(19) United States
(12) Patent Application Publication
(10) Pub. No.: US 2008/0156901 A1
(43) Pub. Date: Jul. 3, 2008

(54) Misting Device with Maximum Decontamination

(76) Inventors: Lionel Nicolai, Vitrolles (FR); Alain Nicolai, Allauch (FR); Robert Castro, Marseille (FR); Marc Lassus, Marseille (FR)

Correspondence Address: JAMES C. LYDON, 100 DAINGERFIELD ROAD, SUITE 100, ALEXANDRIA, VA, 22314, US

(21) Appl. No.: 11/884,465

(22) PCT Filed: Mar. 2, 2006
(86) PCT No.: PCT/FR06/00467

§ 371 Date: Aug. 16, 2007

(30) Foreign Application Priority Data
Mar. 3, 2005 (FR) 0502154

(51) Int. Cl. F24F 6/14; B05B 9/04

(52) U.S. Cl. 239/373; 454/337

(57) ABSTRACT

The invention concerns a humidifier comprising a fogging ramp (14), a water source (10) for feeding the humidifying manifold, a pump (12) adapted to supply water under high pressure to the humidifying manifold, at least one particulate filter (50, 52) retaining the particles having a size greater than about 1μ and receiving water from the source, an ultrafiltration filter (18) receiving water from the particulate filter to retain microorganisms having a size greater than 0.2 μm, and a UV-C manifold chamber (20) including one or more UV-C lamps arranged in quartz sheaths for receiving water from the ultrafiltration filter and adapted to destroy micro-organisms whereof the size is greater than 0.2 μm. The device further comprises a metering pump (53) arranged next to the UV-C manifold chamber and regularly supplying biocidal or virucidal products to prevent a biofilm from being formed in the pipes between the pump and the humidifying manifold.

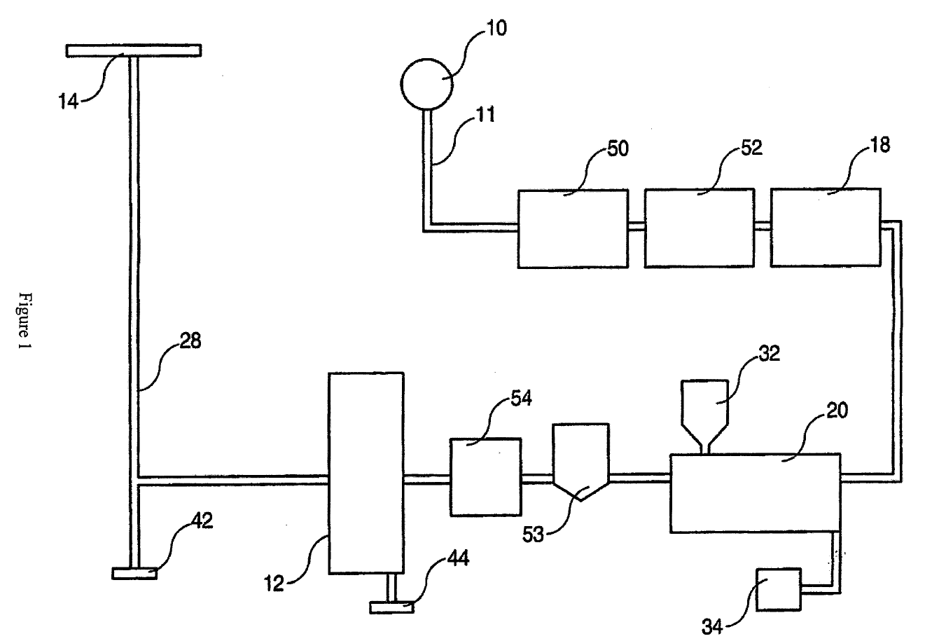

### FIELD OF THE INVENTION

The present invention relates to water misting devices intended mainly for any places requiring perfect hygiene from the bacteriological standpoint, such as industrial installations requiring misting devices, and relates in particular to a misting device with maximum decontamination.

### STATE OF THE ART

Misting of a liquid, and in particular misting using water, is a cooling technique which is used increasingly in public places in order to combat heat exhaustion, particularly during the hottest days of summer. It consists of projecting micro-droplets of water, whose size varies from 3 to 20μ, by means of misting nozzles and a pump at a high pressure between 45 and 110 bars.

It is a relatively economical process which is adaptable, effective and well accepted by the users. Unfortunately, very few precautions are taken in existing systems to make sure that the sprayed water does not contain pathogenic microorganisms. Yet the technique of misting, because of its intrinsic characteristics, has the ability to promote proliferation of microorganisms.

This is particularly true for the risks of contamination by legionella bacteria. Now, the announced cases of legionella infection are constantly increasing in number, and the majority of these cases more particularly concern people in a weakened state, such as elderly people with chronic diseases, but also more recently, the youngest people. This contamination is mainly due to one category of legionella bacteria, Legionella pneumophilia.

The process of contamination also pertains to other bacteria and viruses leading to diseases such as SARS or avian influenza. These diseases can be transmitted by any aerolization processes such as misting that generate droplets the inhalation of which by the respiratory passages can generate extremely serious, often fatal, pulmonary disorders.

### DISCLOSURE OF THE INVENTION

The aim of the invention is therefore to provide a misting device in which the droplets of liquid supplied by the misting nozzles do not contain any pathogenic microorganisms.

The invention therefore relates to a misting device which has a misting manifold containing a number of misting nozzles, a source of liquid providing the liquid intended for feeding the misting manifold, and a pump suitable for supplying the liquid coming from the source to the misting manifold under high pressure, generally between 45 and 110 bars. The device also has one particle filter which retains the particles larger than approximately 1μ and which receives the liquid coming from the source, an ultrafiltration filter which receives the liquid coming from the particle filter in order to retain the microorganisms larger than 0.2μ, and a chamber with a UVC bank, containing one or more UVC lamps placed in quartz sleeves, which receives the liquid coming from the ultrafiltration filter and which is suitable for destroying the microorganisms smaller than 0.2μ. The device moreover has a metering pump placed after the UVC bank chamber, the metering pump regularly supplying biocidal or virucidal products in the pipes between the pump and the misting manifold.

### BRIEF DESCRIPTION OF THE DRAWINGS

The aims, objects and characteristics of the invention will appear more clearly upon reading of the following description given in reference to the single FIGURE, which is a block diagram representing a preferred embodiment of the misting device according to the invention.

### DETAILED DESCRIPTION OF THE INVENTION

Although the device according to the invention represented in the FIGURE can use any liquid, the preferred embodiment described below uses water.

The embodiment of the misting device illustrated in the single FIGURE is mainly used in industrial installations requiring continual misting, such as paper mills or waste drop-off centers, but also poultry farming installations or greenhouses. It can also be used in hospital environments and retirement homes.

Like any misting device of this type, it has water source 10 which is generally the water distribution network, pump 12 suitable for supplying water coming out under high pressure between 45 and 110 bars, and misting manifold 14 containing misting nozzles (not shown). Although the invention does not relate to this, it is recalled that misting consists of introducing fine droplets of water into the air, which evaporate very quickly. This causes changes in the physical characteristics of the ambient air which are expressed by an increase of relative humidity and adiabatic cooling (that is to say without exchange of heat with the exterior) by evaporation of the water leading to a lowering of the temperature of the atmosphere. The nozzles consist of a pressurization chamber in which a stainless steel cylinder with fins is situated. The water projected against this cylinder functions as lubricant causing it to turn, and it is broken up into microscopic particles smaller than 10μ which are carried outside by the high pressure. A stream of air is created inasmuch as the degree of relative humidity of the air of the whole room tends to become uniform. A natural ventilation of the room is then obtained. It should be noted that it is also possible to install a fan if one wishes to obtain faster ventilation.

Water intake pipe 11 coming from source 10 brings the water to a series of three filters, two particle filters 50 and 52 and ultrafiltration filter 18 followed by a UVC (Ultra Violet Type C) ultraviolet radiation bank 20 for destroying all the microorganisms smaller than 0.2μ and mainly the viruses which are too small to be retained by the ultrafiltration filter.

First filter 50 is a positively charged filter which stops all the particles larger than 4.5μ. Second filter 52 stops all the particles and colloidal material larger than 0.5μ. Since the UVC bank can only function correctly if the water is not turbid, it is therefore necessary to reduce the turbidity of the water as well as the materials in suspension (MES). Hence the need to place particle filters upstream.

Ultrafiltration filter 18 retains a large fraction of the microorganisms, that is to say those larger than 0.2μ, and which without this could create a screen for the microorganisms of infinitesimal size such as the viruses which are eliminated by the UVC bank, and in particular retains the bacteria present in the water.

It should be noted that particle filter 50, which protects the two filters that follow, is inexpensive and is changed frequently, for example, once per month. The second filter 52 is only changed every six months, and ultrafiltration filter 18, which is more expensive, can be changed only once per year.

UVC bank 20 is composed of one or more low pressure mercury vapor lamps emitting at the germicidal wave length of 253.7 to 258 nanometers. These lamps are placed in quartz sleeves. The water circulates in treatment chamber 20 around the quartz sleeves. These sleeves are used for separation between the lamp or lamps and the liquid, as electrical and thermal insulation, and make operation at an optimal temperature possible.

UV meter 32 continually indicates, as a percentage with respect to the intensity emitted from the lamp at the beginning of its life, the intensity received at the most unfavorable point of the chamber. It constitutes an indicator of effectiveness which takes into account all the parameters influencing the performance such as aging of the lamps, fouling of the quartz sleeves covering the lamps and deterioration of the quality of the water. The UV meter makes it possible to drive an alarm device (not shown) which is triggered when the intensity emitted by the lamps is insufficient to ensure complete decontamination of the water.

Automatic cleaning device 34 can be connected to UVC bank chamber 20. This device acts by scraping in order to eliminate deposits possibly formed on the quartz sleeves and thus masking the radiation. This device therefore prevents one from having to remove the lamps and empty the chamber. It can be triggered according to two modes of operation: either by the lowering of the intensity of the UVC radiation measured by UV meter 32, or by programming of a regular cycle which depends on the duration of operation of the UVC lamps.

In industrial applications, the misting manifolds can have total lengths of 400 m. In order to make the whole device safe, it is therefore absolutely necessary to be able to prevent the formation of a biofilm of microorganisms such as legionella bacteria in the pipes running to the misting manifold by regular treatment by means of metering pump 53 enabling regular injection of products which combat the formation of this biofilm. Such products are biocidal compounds which destroy the bacteria, or preferably virucidal compounds which destroy the viruses as well as the bacteria. In this way, the quality of the water circulating in the device will be equal to that obtained coming out of the UVC bank.

Since the products supplied by metering pump 53 can lead to rapid plugging of the misting nozzles, it is wise to add anti-particle filter 54 in order to stop particles larger than 5μ coming out of metering pump 53.

The misting device is emptied regularly so as to eliminate the slightest risk of contamination. To do this, there are two drain outlets situated in the low part: drain outlet 42 for the misting manifold and drain outlet 44 for the pump.

It should be noted that all the pipes connecting the elements of the misting device, such as pipe 11 coming from source 10 or pipe 28 connecting pump 12 to misting manifold 14, are preferably made of copper, which is a bactericidal metal, or of copper alloy.

The misting device according to the invention can also be used in public places such as highway rest areas, stations, airport lobbies, or in private places such as patios, restaurant terraces, stores, etc. It can also be used in trade locations such as greenhouses, fish stalls, vegetable stalls or in wet air cooling towers (TAR).

1-9. (canceled)

10. A misting device comprising
a misting manifold containing a number of misting nozzles,
a source of liquid which supplies the liquid intended for feeding said misting manifold, and
a pump suitable for supplying the liquid coming from said source to said misting manifold at high pressure;
said device also comprising at least one particle filter which receives the liquid coming from said source and which retains particles larger than approximately 1μ, an ultrafiltration filter which receives the liquid coming from said particle filter in order to retain microorganisms larger than 0.2μ, and a chamber with a UVC bank consisting of one or more UVC lamps placed in quartz sleeves, which receives the liquid coming from said ultrafiltration filter and which is suitable for destroying microorganisms smaller than 0.2μ;
said device further comprising a metering pump placed after said UVC bank chamber, said metering pump regularly supplying biocidal or virucidal products in the pipes between said pump and said misting manifold for the purpose of preventing the formation of a biofilm.

11. The device of claim 10, further comprising a UV meter associated with said UVC bank chamber, said UV meter continually indicating the dose received at the most unfavorable point of the chamber as a percentage with respect to the intensity emitted at the beginning of the life of the lamp or lamps.

12. The device of claim 11, further comprising an automatic cleaning device associated with said UVC bank chamber, said automatic cleaning device acting by scraping in order to eliminate deposits possibly formed on the quartz sleeves surrounding the lamps.

13. The device of claim 10, wherein said at least one particle filter which retains particles larger than 1μ is followed by a second particle filter which retains particles or colloidal substances larger than 0.5μ.

14. The device of claim 13, further comprising a particle filter which retains particles larger than 5μ and which is placed after said metering pump.

15. The device of claim 13, further comprising drain outlets situated in a lower part of said device.

16. The device of claim 10, wherein all the pipes connecting the elements of the misting device are made of copper.

17. The device of claim 10, wherein said liquid source is a water source.

18. Use of the device of claim 10 in industrial or poultry farming installations requiring a misting device.

19. The device of claim 10, wherein said pump is capable of supplying said liquid at a pressure of from 45 to 110 bars.

20. The device of claim 15, wherein said outlets comprise a drain outlet for said misting manifold and a drain outlet for said pump.

21. The use of claim 18, wherein said industrial installation is a paper mill.
